(19) United States
(12) Patent Application Publication
(10) Pub. No.: US 2019/0192380 A1
(43) Pub. Date: Jun. 27, 2019

(54) CARDIOPULMONARY RESUSCITATION DEVICE

(71) Applicants: Aimee Tomlinson, Harrison Township, MI (US); Meagan Mazurek, Oak Park, MI (US)

(72) Inventors: Aimee Tomlinson, Harrison Township, MI (US); Meagan Mazurek, Oak Park, MI (US)

(21) Appl. No.: 15/852,502

(22) Filed: Dec. 22, 2017

(51) Int. Cl. A61H 31/00

(52) U.S. Cl. CPC A61H 31/005; A61H 31/007; A61H 2201/5061; A61H 2201/1207; A61H 2201/1645; A61H 2201/1619; A61H 2201/5043

(57) ABSTRACT

A cardiopulmonary resuscitation (CPR) device comprising: (I) a flexible substrate having opposing substantially flat surfaces; (II) one or more sensors disposed within the substrate between the substantially flat surfaces, the one or more sensors configured to measure a force applied to the substrate; and (III) a power supply electrically connected to the substrate, wherein a controller located within a housing of the power supply receives an input from the one or more sensors and outputs a signal to an indicator located on at least one of the substantially flat surfaces to visually indicate a value of the force.

### FIELD

The present teachings generally relate to a cardiopulmonary resuscitation (CPR) device. More specifically, the CPR device provides an operator with a flexible substrate electrically connected to a power supply for monitoring and tracking feedback from one or more sensors located on the flexible substrate.

### BACKGROUND

Cardiopulmonary resuscitation (CPR) devices are used both commercially and privately to aid in resuscitating a cardiac arrest patient. Cardiac arrest occurs when there is an electrical malfunction in the heart of a patient. This malfunction causes the heart to beat irregularly and disrupt blood flow, leading to fatigue and eventually death. To combat cardiac arrest, an operator, typically an Emergency Medical Technician (EMT), doctor, nurse, or other medically trained professional, performs CPR by compressing the patient's chest directly above the heart and at times manually provide ventilation (i.e., air) to the patient's lungs.

However, due to the high stress nature of a situation requiring CPR on a patient, it is often difficult for a user to correctly apply CPR based on the recommended guidelines from the American Heart Association. For example, a user is recommended to complete 30 chest compressions at a rate of 100 to 120 compressions per minute on the patient. Therefore, it is frequently difficult for the user to not only maintain chest compression, but also consciously keep track of the number of compressions to maximize blood flow to the patient's brain. Furthermore, it is often problematic for a user to apply a chest compression pressure within the designated guidelines, or maintain a constant compression pressure due to fatigue in the user's hands. For example, a user applying too high of a pressure could cause severe tissue damage to the patient, while too low of a pressure may not effectively provide proper blood flow to the patient's brain.

To help accommodate the consistency and accuracy problems identified above when performing CPR to a patient, a variety of CPR devices were created. Examples of such devices include those described in U.S. Pat. Nos. 6,125,299; 8,034,006; 8,600,522; 9,173,807; 9,370,462; and 9,486,390; and U.S. Publication Nos. 2015/0335522; 2015/0045697; and 2017/0281461. However, the devices may be difficult to operate; difficult to position on a patient; uncomfortable or harmful to the user, patient, or both; may not provide a sufficient amount of data output; may be difficult to transport; or a combination thereof. Additionally, the devices may be expensive and heavy due to excessive materials and components being utilized.

It may be attractive to have a CPR device that allows a user to effectively position the device on a chest of a patient; that is lightweight and easy to transport; that is comfortable for both a patient and user during operation of the device; that is cost effective and lightweight; and that sufficiently receives and outputs parameters of the CPR application. Therefore, what is needed is a CPR device that includes a substrate small enough to position on a patient's chest. What is needed is a lightweight device having a packaging size small enough for a user (e.g., an EMT) to transport from site to site. What is needed is a CPR device having a flexible substrate that does not harm the user, the patient, or both. What is needed is a CPR device having a power supply that receives inputted data from a sensor of the device and outputs one or more parameters for a user to reference.

### SUMMARY

The present teachings meet one or more of the present needs by providing: a cardiopulmonary resuscitation (CPR) device comprising: (I) a flexible substrate having opposing substantially flat surfaces; (II) one or more sensors disposed within the substrate between the substantially flat surfaces, the one or more sensors configured to measure a force applied to the substrate; and (III) a power supply electrically connected to the substrate, wherein a controller located within a housing of the power supply receives an input from the one or more sensors and outputs a signal to an indicator located on at least one of the substantially flat surfaces to visually indicate a value of the force.

The present teachings meet one or more of the present needs by providing: a cardiopulmonary resuscitation (CPR) device comprising: (I) a flexible substrate; (II) a pressure sensor disposed within the substrate, the sensor configured to measure a force applied to the substrate; and (III) a power supply electrically connected to the substrate via a wire, wherein the power supply receives an input from the sensor and outputs a signal to an indicator located on a surface of the flexible substrate to visually indicate a value of the force.

The present teachings meet one or more of the present needs by providing a method for using a cardiopulmonary resuscitation (CPR) device comprising: (I) placing the substrate on a chest cavity of a patient; (II) powering on the power supply by switching a power switch located on an exterior of the power supply; and (III) applying a repetitive sequence of compression forces within a desired range to the substrate and the chest cavity based on the acceptable value illustrated by the indicator.

The present teachings provide a CPR device having a substrate that is small enough to position on a patient's chest. The present teachings provide a CPR device lightweight and transportable by a user. The present teachings provide a CPR device having a flexible substrate that prevents harm to the chest of the patient, the user, or both. The present teachings provide a CPR device having a power supply the receives inputted data from a sensor of the device and outputs one or more parameters for a user to reference.

### BRIEF DESCRIPTION OF THE DRAWINGS

FIG. 1 illustrates a perspective view of a CPR device;

FIG. 2 illustrates a cross-sectional view of a CPR device having a plurality of substrates;

FIG. 3 illustrates a cross-sectional view of a CPR device having a substrate;

FIG. 4 illustrates a perspective view of a CPR device electrically connected to a power supply;

FIG. 5 illustrates cross-sectional view 5-5 of FIG. 4;

FIG. 6 illustrates a perspective view of a CPR device in accordance with the present teachings disposed on a patient; and

FIG. 7 illustrates a perspective view of a CPR device having an integrated power supply.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a cardiopulmonary resuscitation (CPR) device for aiding in the application of CPR. The CPR device may monitor one or more parameters (e.g., chest compression count, chest compression force, time elapsed, etc.) and provide feedback to a user of the CPR device. The CPR device may include one or more integrate components to create the CPR device. For example, the CPR device may include one or more substrates, one or more sensors, one or more power supplies, or a combination thereof. The CPR device may be configured for operation of applying CPR to a patient. The CPR device may be configured for operation other than applying CPR to a patient. For example, the CPR device may be configured for testing exercises on a training dummy to provide feedback to the user, an instructor, or both. The CPR device may be lightweight and transportable. For example, the CPR device may be sufficiently lightweight so that a user such as an EMT may carry the CPR device on themselves, in their vehicle, or both. The CPR device may provide added comfort to a user, a patient, or both. The CPR device may include one or more electronics to process and control the CPR device. The CPR device may include a first portion configured to rest on a patient's chest, and a second portion away from the patient to supply power and computing control. For example, the CPR device may include a substrate to place on the patient's chest, and the substrate may be electrically connected to a power supply.

The substrate may function to receive input from a user's actions during CPR application. The substrate may function to communicate between a user's actions (e.g., chest compressions) and a power supply. The substrate may function to receive a compression force from the user when the user is compressing a chest of a patient or testing dummy. For example, the substrate may include one or more sensors to measure the compression force being applied to the substrate and patient or testing dummy. The substrate may be positioned between a user's hands and a chest of a patient. For example, the substrate may be positioned directly on a patient's chest where a user will apply proper CPR compressions. The substrate may be substantially rigid or may be flexible. For example, the substrate may be flexible so that the substrate can be compressed similar to the chest of the patient or testing dummy. The substrate may vary in shape and dimensions. For example, the substrate may be circular, oval, rectangular, square, trapezoidal, or a combination thereof. The substrate may have a thickness large enough to incorporate one or more sensors or one or more electronics, but small enough to not inhibit chest compressions being applied to a patient or testing dummy. The substrate may have a thickness of about 1 mm or more, about 2 mm or more, about 3 mm or more, or about 4 mm or more. The substrate may have a thickness of about 8 mm or less, about 7 mm or less, about 6 mm or less, or about 5 mm or less. The substrate may be comprised of a plurality of individual substrates. For example, the substrate may include a first substrate and a second substrate so that the first and second substrates are sandwiches together to form the overall substrate. The plurality of substrates may sandwich the one or more sensors, one or more electronics, or both in between the plurality of substrates. The substrate may be integrally formed of one piece.

The substrate may be injection molded, extruded, cast, three-dimensionally printed, or a combination thereof. The substrate may be metal, plastic, or both. The metal may be aluminum, copper, tin, iron, steel, brass, tungsten, or a combination thereof. The plastic may be a polyamide, polycarbonate, polyester, polyethylene, polypropylene, polystyrene, polyurethane, polyvinyl, or a combination thereof. The substrate may be a material other than metal. For example, the substrate may be a polysiloxane, silicone, rubber, foam, or a combination thereof.

The substrate may include one or more substantially flat surfaces. For example, the substrate may be substantially box-shaped and include a plurality of substantially flat surfaces. The substrate may include one or more contoured portions. For example, the substrate may include one or more curvatures along one or more surfaces. The substrate may include one or more friction materials on one or more surfaces. The one or more friction materials may increase friction between the substrate and a patient, testing dummy, a user's hands, or a combination thereof. The one or more friction materials may be an adhesive or a coarse material. The substrate may be free of friction materials. For example, the substrate may include one or more flat surfaces to minimize friction between the substrate and the patient, the testing dummy, the user, or a combination thereof. The substrate may be free of sharp (i.e., substantially right-angled) edges or corners to minimize harm to a patient, a testing dummy, a user, or a combination thereof. The substrate may be compressible. The substrate may be compression resistant. The substrate may form to a contour of a patient, a testing dummy, a user's hands, or a combination thereof. For example, the substrate may be a foam that elastically forms around a chest contour of a patient during application, but returns to an original shape after application. The substrate may include one or more sensors that monitor one or more parameters of the CPR application.

The one or more sensors may function to receive an input from a user applying CPR to a patient, a testing dummy, or both. The one or more sensors may function to transmit an input to the one or more components of the power supply. The one or more sensors may measure one or more parameters. For example, the one or more sensors may measure chest compression force, chest compression count, movement of the substrate, compression depth, velocity, acceleration, motion, light, patient vitals (e.g., heartrate or blood pressure), power supply (e.g., voltage), or a combination thereof. The one or more sensors may be an accelerometer, a pressure sensor (e.g., a piezoresistive or piezoelectric pressure sensor), Hall effect sensor, infrared sensor, oxygen sensor, voltage detector, gyroscopic sensor, inclinometer, photoelectric sensor, position sensor, ultrasonic thickness gauge, load cell, thermometer, or a combination thereof. The one or more sensors may be positioned on one or more surfaces of the substrate. The one or more sensors may be integrally formed with the substrate. For example, the one or more sensors may be overmolded into the substrate so that the one or more sensors are substantially flush or recessed from one or more surfaces of the substrate. The one or more sensors may be 2 or more sensors, 3 or more sensors, or 4 or more sensors. The one or more sensors may be 7 or less sensors, 6 or less sensors, or 7 or less sensors. The one or more sensors may be powered via one or more power supplies. The one or more power supplies may be integrally formed with the one or more sensors or may require secondary power supply via one or more wires. The one or more sensors may be free of remote power supplies. For example, the one or more sensors may include a photovoltaic cell to charge the one or more sensors. The one or more sensors may be positioned on a component other than the substrate. For example, the one or more sensors may be located in the power supply of the CPR device. The one or more sensors may receive an input so that the power supply may output a signal to an indicator.

The indicator may function to output data to a user. The indicator may function to indicate parameters of a CPR application during the CPR application. The indicator may be visual indicators, acoustic indicators, or both to indicate to a user, a patient, or both. For example, the indicator may include one or more lights (e.g., LED lights) to visually indicate a pressure force currently being applied to the substrate and one or more sensors. The one or more lights may vary in color to designate a specific range of a desired chest compression force. For example, a plurality of lights may include a green light indicating a targeted compression force, a red light indicating an unacceptable compression force, and a plurality of white or yellow lights indicating that a force has not yet reached the threshold. Alternatively, the indicator may include a screen so that a counter or timer may indicate time elapsed, number of compressions, pressure force, or a combination thereof. The indicator may include one or more speakers or noise makers to acoustically indicate a parameter to a user. For example, a beep may occur when a user has reached a threshold number of chest compressions or reached a threshold compression force. The indicator may be integrally formed with the substrate, the power supply, or both. The indicator may protrude or project from a surface of the substrate. Alternatively, the indicator may be substantially flush or recessed from one or more surfaces of the substrate. The indicator may be powered by the power supply. The indicator may be removably attached to the substrate, the power supply, or both. The indicator may be replaceable. For example, lights within the indicator may be replaced when damaged or expired. The indicator may be used in conjunction with an instructional print to properly apply CPR to a patient, a testing dummy, or both.

The instructional print may function to instruct a user on how to properly apply CPR. The instructional print may function to list a set of rules, warnings, recommendations, steps, or a combination thereof for reference to a user. For example, the instructional print may list the recommended steps for applying CPR to a patient for reference by a user during CPR application. Alternatively, the instructional print may provide operator instructions to a user regarding how to use the CPR device. The instructional print may be printed directly onto one or more surfaces of the substrate. The instructional print may be carved or etched into the substrate. The instructional print may be a secondary print that is applied to the substrate. For example, the instructional print may be a sticker or adhesive-backed material that is adhered to the substrate. The instructional print may be a digital display that electronically displays the rules, warnings, recommendations, steps, or a combination thereof. The instructional print may vary in size (i.e., footprint) along the substrate. The instructional print may include a variety of fonts and font sizes. The instructional print may be located in a position on the CPR device other than on the substrate. For example, the instructional print may be located on the power supply.

The power supply may function to power the CPR device. The power supply may function to provide power to the substrate of the CPR device. The power supply may function to receive an input from the one or more sensors. The power supply may function to analyze one or more inputs from the one or more sensors and provide an output. The power supply may include one or more electronic components such as a printed circuit board, microprocessor, power switch, power cell, or a combination thereof. The power supply may be integrally formed with the substrate. For example, the power supply may be attached to a surface of the substrate. Alternatively, the power supply may be overmolded with the substrate. The power supply may electrically connect the one or more electronic components, the one or more sensors, the indicator, or a combination thereof via one or more wires. The power supply may be a secondary component not integrally formed with the substrate. For example, the power supply may include a housing.

The housing may function to house the power supply. The housing may function to protect the power supply from outside elements such as moisture, debris, or both. The housing may be structurally rigid, or more be flexible. The housing may be metal, plastic, or both. The housing may be stamped, cast, injection molded, extruded, three-dimensionally printed or a combination thereof. The housing may be sufficiently lightweight so that a user may transport the power supply with the substrate from one location to a second location. The housing may vary in shape and dimensions. For example, the housing may substantially cubed. The housing may be integrally formed or may include a plurality of separate components. For example, the housing may be a box formed by a plurality of walls fastened together. The housing may include one or more access doors or panels. The housing may include one or more covers. For example, the housing may include a removable cover to access the interior of the housing. The housing may include a power output. For example, the power outlet may connect the power supply to the substrate via one or more wires to create electrical power and communication between the power supply and the one or more sensors located on the substrate. The power outlet may be connected to a power input located on the substrate. The housing may be moisture resistant. The housing may be corrosion resistant. The housing may include one or more handles to transport the power supply. The housing may house a power cell of the power supply.

The power cell may function to power the CPR device. The power cell may function to power the substrate, the power supply, or both. The power cell may be located within the housing of the power supply. The power cell may be integrally formed or located on the substrate of the CPR device. The power cell may be a battery. The battery may be lead-acid, lithium-ion, alkaline, aluminum-ion, or a combination thereof. The power cell may be solar powered. For example, the power cell may be a photovoltaic cell. The power cell may power the CPR device free of external connection to one or more ground power supplies (e.g., a wall plug). The power cell may be a plurality of batteries or may be a single battery. The power cell may be rechargeable. The power cell may be replaceable. The power cell may be directly or indirectly connected to a controller of the power supply.

The controller may function to control operation of the CPR device. The controller functions to control interaction between the substrate and the power supply. For example, the controller functions control interaction between the one or more sensors, indicator, or both and the power supply. The controller may control input and output of data transmitted between the one or more sensors, indicator, or both and the power supply. The controller may be directly or indirectly connected to a printed circuit board (PCB).

The PCB may function to electrically connect the controller, the power cell, the one or more sensors, the indicator, or a combination thereof, with one another. The PCB may mechanically support the controller, the power cell, the one or more sensors, the indicator, a microprocessor, or a combination thereof. The PCB may include one or more circuits to relay data between the one or more electrical components. The PCB may include one or more resistors, one or more capacitors, one or more transistors, one or more memory chips, one or more electrical substrates, or a combination thereof. The PCB may be located within a power supply remote from the substrate or may be located within a power supply integrally formed with the substrate. The PCB may operatively connect to a microprocessor of the power supply.

The microprocessor may function to process inputs and outputs of data of the CPR device. The microprocessor may function to compute and analyze data received from the one or more sensors, power switch, or both. The microprocessor may use one or more algorithms or equations to compute and analyze the data received so that the data may be output to the indicator or a display for a user to view. The microprocessor may be located with a power supply remote from the substrate or may be located within a power supply integrally formed with the substrate. The microprocessor may control powering on and off the CPR device based on user toggling of a power switch.

The power switch may function to communicate with the microprocessor, the PCB, the controller, or a combination thereof to turn on and off the CPR device. The power switch may include one or more positions so that a user may interact with the power switch to turn the CPR device on and off. The power switch may be a button, toggle, ignition, dial, electrical touch pad, remote, or a combination thereof. The power switch may be located on the substrate, the housing of the power supply, or both. For example, the power switch may be located on an exterior surface of the housing so that a user, a patient, or both may access and toggle the power switch between an “on” and “off” position. The “on” position may trigger the power cell to provide power throughout the CPR device. The “off” position may disconnect the power cell from the CPR device. The power switch may be voice activated. The power switch may be triggered by connection to a patient. For example, when the substrate is disposed on a patient, the power switch automatically turns on the CPR device. The power switch may be located within the power supply and require no physical interaction from a user to toggle the CPR device between an on and off position. The power switch may toggle a display of the power supply to turn on to indicate that the CPR device is functional.

The display may function to display information for a user. The display may show one or more parameters of the CPR device. For example, the display may show chest compression force, chest compression count, movement of the substrate, compression depth, velocity, acceleration, power supply voltage, power supply capacity, time, power status (e.g., “on,” “off,” “standby,” or a combination thereof), or a combination thereof. The display may include one or more lights. For example, the display may include a backlight, one or more LED lights, or a combination thereof. The display may be located on the substrate, the housing of the power supply, or both. The display may be powered by the power cell. The display may have an independent power source. The display may be controlled by the PCB, the microprocessor, the controller, or a combination thereof. The display may work in conjunction with the indicator to display similar data, or the display and indicator may indicate different data. The display may display a plurality of parameters simultaneously. The display may be configurable to display desired parameters based on input from the user, the patient, or both. For example, the display may include one or more buttons to toggle between a plurality of output parameters.

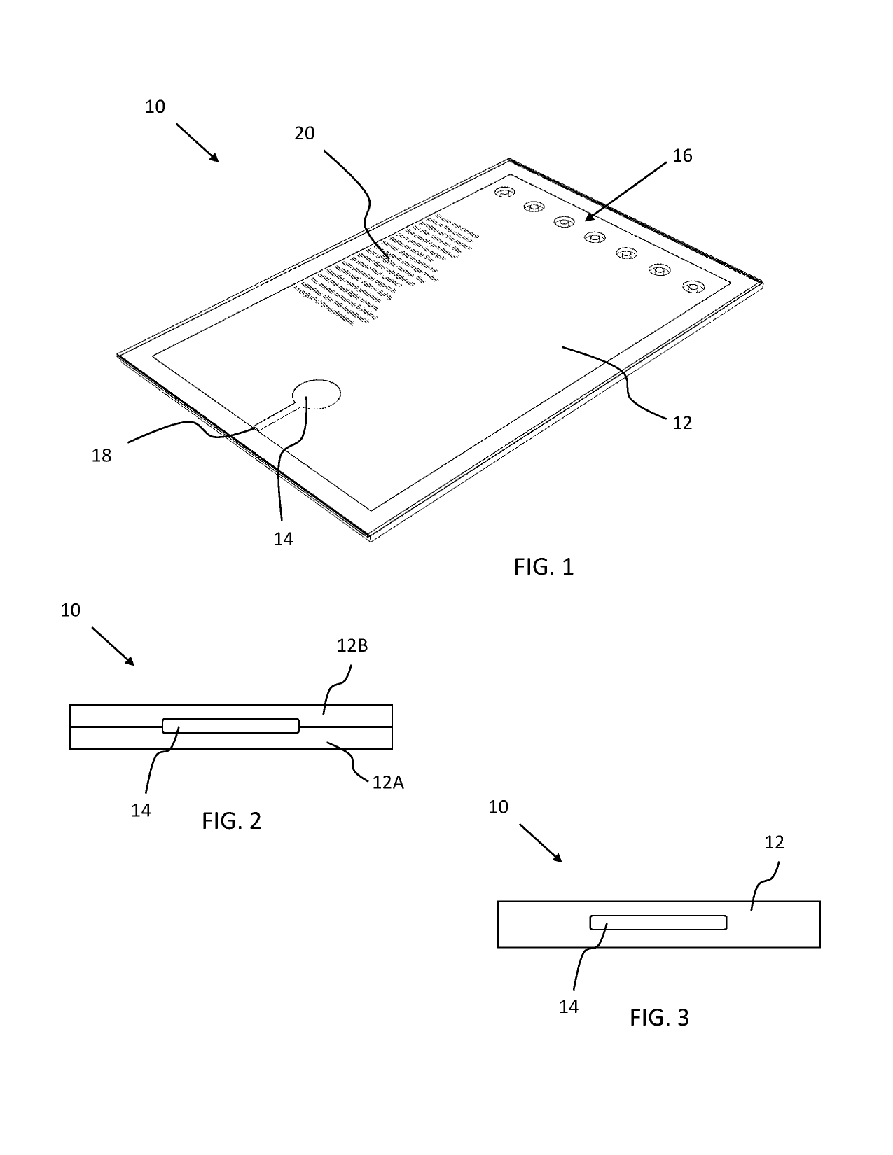

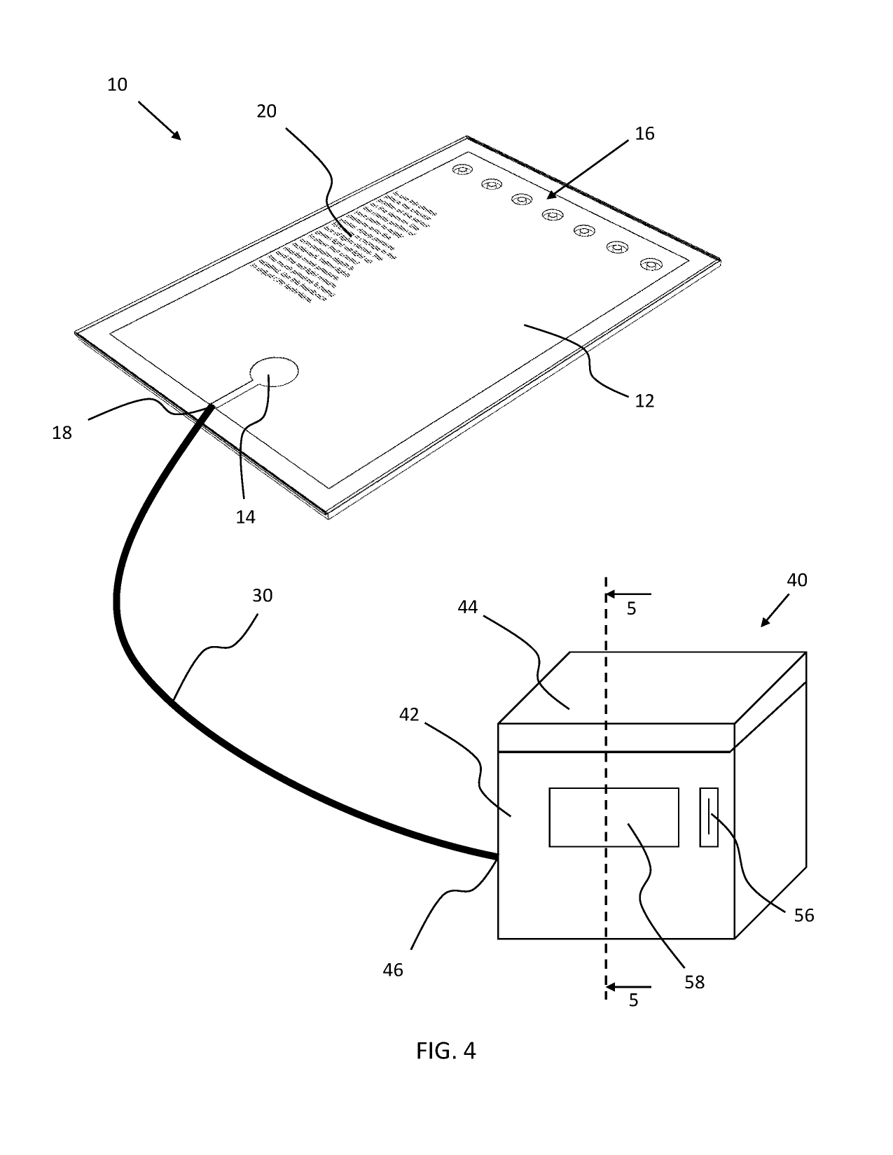

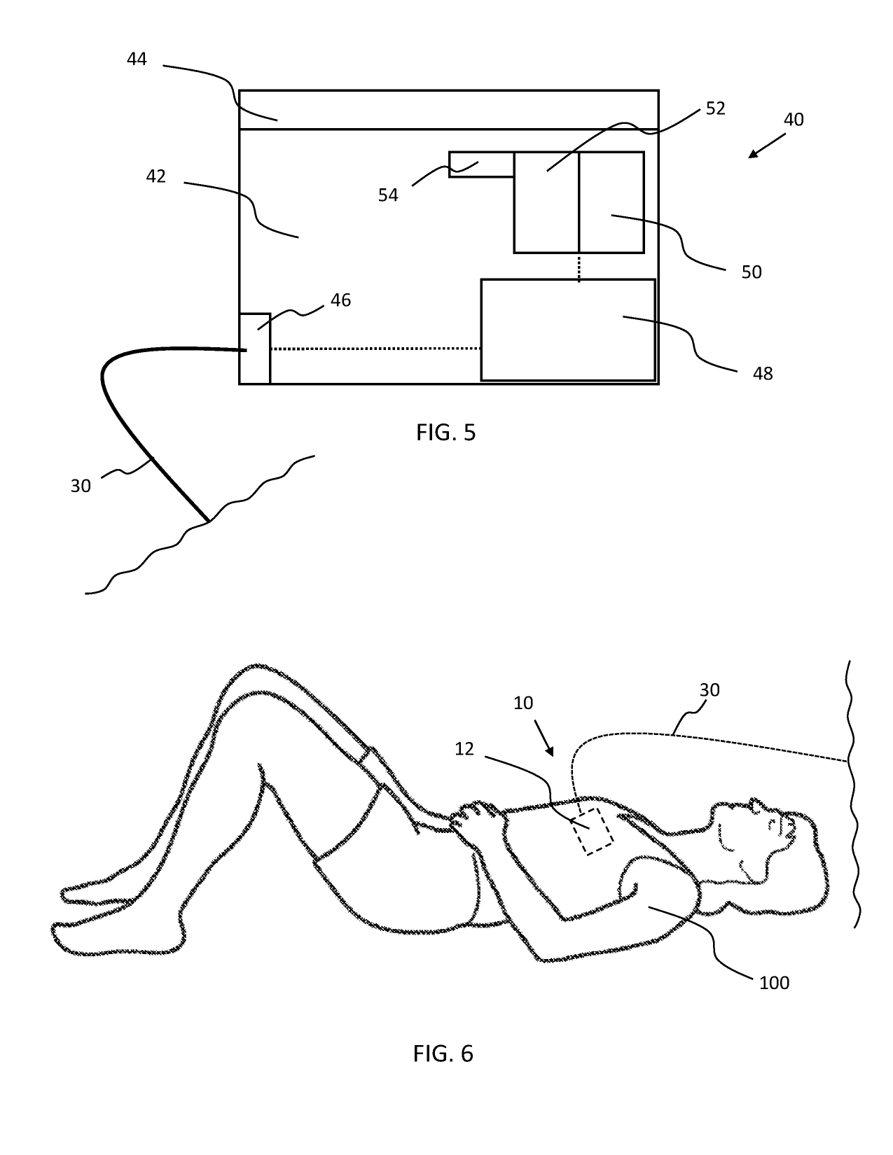

Turning now to the figures, FIG. 1 illustrates a perspective view of a CPR device 10. The CPR device 10 includes a sensor 14 disposed within a substrate 12, the sensor 14 being recessed or flush from one or more surfaces of the substrate 12. The CPR device 10 further includes an instructional print 20 and indicator 16 for indicating an output of a power supply (not shown). The CPR device 10 is electrically connected to a power supply by a wire connected to a power input 18 of the CPR device 10 (see FIG. 4). The power supply receives an input from the sensor 14 and provides an output to the indicator 16.

FIG. 2 illustrates a cross-sectional view of a CPR device 10 having a plurality of substrates 12. The CPR device 10 includes a first substrate 12A and a second substrate 12B disposed on the first substrate 12A. A sensor 14 is sandwiched between the first substrate 12A and the second substrate 12B.

FIG. 3 illustrates a cross-section view of a CPR device 10 having a substrate 12. The CPR device 10 further includes a sensor 14 disposed within a thickness of the substrate 12.

FIG. 4 illustrates a perspective view of a CPR device 10 electrically connected to a power supply 40. The CPR device 10 includes a sensor 14 disposed within a substrate 12, the sensor 14 being recessed or flush from one or more surfaces of the substrate 12. The CPR device 10 further includes an instructional print 20 and indicator 16 for indicating an output of the power supply 40. The CPR device 10 is electrically connected to the power supply 40 via a wire 30 extending between a power input 18 located on the substrate 12 and a power output 46 of the power supply 40. The power supply 40 receives an input from the sensor 14 and provides an output to the indicator 16. The power supply 40 includes a housing 42 and a removable lid 44 located along a top portion of the housing 42. A display 58 located on an exterior surface of the housing 42 displays data received, transmitted, or both by the power supply 40. The power supply 40 further includes a power switch 56 to turn on and off power being transmitted throughout the CPR device 10.

FIG. 5 illustrates a cross-sectional view along line 5-5 of FIG. 4. The power supply 40 includes a controller 50, a printed circuit board 52, and a microprocessor 54 electrically connected and located within a housing 42 of the power supply 40. A power cell 48 powers the controller 50, the printed circuit board 52, and the microprocessor 52. A wire 30 is connected to a power output and supplies power received from the power cell 48 to a power input of the substrate (see FIG. 4). The housing 42 further includes a removable lid 44 disposed along a top portion of the housing 42.

FIG. 6 illustrates a perspective view of a CPR device 10 utilized on a patient 100. A substrate 12 of the CPR device 10 is disposed on a chest of a patient 100 and electrically powered via a wire 30 connected to the substrate 12 (see FIGS. 4 and 5). The substrate 12 is positioned between the patient 100 and hands of an operator (not shown) to receive input from the operator.

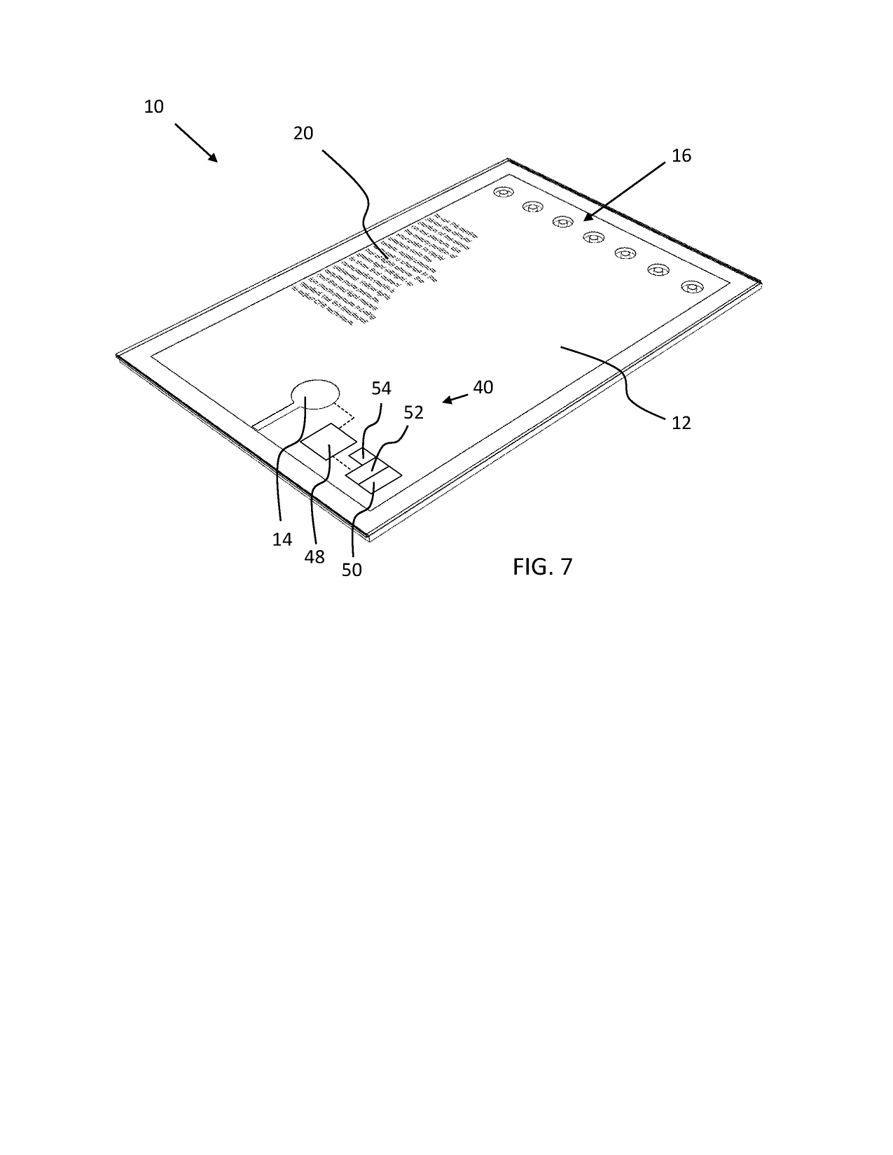

FIG. 7 illustrates a perspective view of a CPR device 10. The CPR device 10 includes a sensor 14 disposed within a substrate 12, the sensor 14 being recessed or flush from one or more surfaces of the substrate 12. The CPR device 10 further includes an instructional print 20 and indicator 16 for indicating an output of the power supply 40 connected to the sensor 14. The power supply 40 includes a controller 50, a printed circuit board 52, and a microprocessor 54 electrically connected and located within the substrate 12. A power cell 48 powers the controller 50, the printed circuit board 52, and the microprocessor 52.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

We claim:

1. A cardiopulmonary resuscitation (CPR) device comprising:
I. a flexible substrate having opposing substantially flat surfaces;
II. one or more sensors disposed within the substrate between the substantially flat surfaces, the one or more sensors configured to measure a force applied to the substrate; and
III. a power supply electrically connected to the substrate,
wherein a controller located within a housing of the power supply receives an input from the one or more sensors and outputs a signal to an indicator located on at least one of the substantially flat surfaces to visually indicate a value of the force.

2. The device according to claim 1, wherein the substrate is silicone, polystyrene, rubber, polyvinyl chloride, or a combination thereof.

3. The device according to claim 1, wherein the controller further outputs a count of the number of force applications applied to the substrate.

4. The device according to claim 1, wherein the power supply further comprises a power cell to power the device.

5. The device according to claim 1, wherein the indicator includes a plurality of lights to indicate the value of the force.

6. The device according to claim 1, wherein the device is configured to be sterilized.

7. The device according to claim 3, wherein the power supply further comprises a display to display the number of force applications.

8. The device according to claim 1, wherein an instructional print is disposed on the substantially flat surfaces.

9. The device according to claim 1, wherein the substrate is transparent.

10. The device according to claim 4, wherein, when a power switch located on an exterior of the housing is turned to an on position, the controller immediately measures the force applied to the substrate.

11. The device according to claim 1, wherein the housing includes a removable cover.

12. The device according to claim 1, wherein the device is a cardiopulmonary resuscitation (CPR) feedback device.

13. The device according to claim 1, wherein the substrate is configured for positioning on a chest cavity of a patient.

14. The device according to claim 1, wherein the force applied to the substrate is applied by one or more hands of an operator.

15. A cardiopulmonary resuscitation (CPR) device comprising:
I. a flexible substrate;
II. a pressure sensor disposed within the substrate, the sensor configured to measure a force applied to the substrate; and
III. a power supply electrically connected to the substrate via a wire,
wherein the power supply receives an input from the sensor and outputs a signal to an indicator located on a surface of the flexible substrate to visually indicate a value of the force.

16. A method for the device according to claim 1, comprising:
I. placing the substrate on a chest cavity of a patient;
II. powering on the power supply by switching a power switch located on an exterior of the power supply; and
III. applying a repetitive sequence of compression forces within a desired range to the substrate and the chest cavity based on the acceptable value illustrated by the indicator.

17. The device according to claim 1, wherein the sensor is an accelerometer.

18. The device according to claim 1, wherein the power supply calculates a duration of time the device is powered on.

19. The device according to claim 5, wherein the plurality of lights is color changing to designate an acceptable force range.

20. The device according to claim 1, wherein the substrate includes a first substrate and a second substrate, and the one or more sensors is disposed between the first substrate and the second substrate.
